(19) United States
(12) Patent Application Publication
(10) Pub. No.: US 2026/0185558 A1
(43) Pub. Date: Jul. 2, 2026

(54) Roller chain for recirculating bearing modules, intended for offshore application

(71) Applicant: REEL, SAINT-CYR-AU-MONT-D'OR (FR)

(72) Inventors: Karamoko KONATE, SAINT ROGATIEN (FR); François BOUTEILLER, AUCHAY SUR VENDEE (FR)

(21) Appl. No.: 19/432,439

(22) Filed: Dec. 24, 2025

(30) Foreign Application Priority Data
Dec. 27, 2024 (FR) 2415339

(51) Int. Cl. F16C 29/06

(52) U.S. Cl. CPC F16C 29/0602

(57) ABSTRACT

The present invention relates to a roller chain (10) for a recirculating bearing module (20), intended for an offshore application.

The roller chain (10) comprises several rollers (11) which are each fitted onto a shaft (12).

The rollers (11) are free to rotate relative to their associated shafts (12). And the cylindrical inner surface (112) of said roller (11) and the outer surface (121) of said shaft (12) define a sealed chamber (15) which is filled with a lubricating fluid.

Each shaft (12) is rotationally locked with at least one associated link (13) by means of rotational locking means (16).

### TECHNICAL FIELD OF THE INVENTION

The present invention relates to the technical field of recirculating bearing modules, intended for offshore applications.

### STATE OF THE ART

In the offshore sector, the need for technological solutions capable of guiding and maneuvering increasingly massive structures continues to grow.

This need is particularly evident in the offshore wind sector, where the installation, positioning and maintenance of equipment require reliable mechanical solutions adapted to these challenging environments.

In order to meet these requirements, it's known to use recirculating bearing modules incorporating roller chains. These chains consist of several rollers, each one fitted onto a shaft which is connected to an adjacent shaft by two links.

These chains enable rapid and controlled movements between mobile frames of an offshore structure, which is essential for optimizing operations in these complex environments.

However, despite their effectiveness, current solutions have significant limitations. The links of conventional roller chains are particularly sensitive to repetitive movements, which can lead to premature degradation or even breakage under the high mechanical stresses characteristic of offshore applications. This weakness represents a major risk, for example in critical operations such as offshore wind turbine installation, where failures can have considerable economic and environmental consequences.

Thus, there is an increased need for new roller chains offering better resistance to dynamic loads.

### PRESENTATION OF THE INVENTION

In order to remedy the aforementioned drawback of the prior art, the present invention proposes a roller chain for a recirculating bearing module, intended for an offshore application.

The roller chain comprises several rollers, each one being fitted onto a shaft. Each shaft has an outer surface and is connected to an adjacent shaft by two links.

And, according to the invention, said rollers, which are tubular in shape, each comprise:
a cylindrical outer surface, and
a cylindrical internal surface, defining a through-hole into which said shaft is fitted,

which rollers are free to rotate relative to their associated shafts,

which cylindrical inner surface of said roller and which outer surface of said shaft define a sealed chamber which is filled with a lubricating fluid,

and each shaft is rotationally locked with at least one of said associated links by means of rotational locking means.

Thanks to the rotational locking of each shaft with at least one of the associated links, the rotational movement takes place mainly between the roller and its shaft (and not between the shaft and the links).

This minimizes friction between the shafts and the links, thus reducing link heating. This reduction in heating limits the risk of thermal degradation and premature wear.

By avoiding excessive stress on the links, the invention prevents breakages due to repetitive movements and mechanical wear. This improves chain life in demanding environments, such as offshore applications.

Reducing the risk of link breakage leads to a reduction in maintenance interventions and associated costs, particularly in hard-to-reach environments such as offshore structures.

By promoting rotational movements at the lubricated surfaces between the roller and the shaft, the invention ensures better resistance to dynamic loads, which is crucial for repeated high-speed operations.

In addition, the design incorporating a sealed chamber filled with lubricating fluid allows a significant reduction in friction forces between the cylindrical inner surface of said roller and the outer surface of said shaft, thus extending the life of the entire chain.

Other non-limiting and advantageous characteristics of the product according to the invention, taken individually or in all technically possible combinations, are as follows:
the roller and its associated shaft cooperate by means of rotational assembly means, advantageously chosen from plain bearings or rolling bearings, advantageously brought together between said cylindrical inner surface of said roller and said outer surface of said shaft;

the means of rotational assembly include two bearings, for example two plain flanged bearings, advantageously made of bronze, which are secured to said cylindrical inner surface, or two rolling bearings, for example ball bearings, roller bearings or needle bearings;
said sealed chamber is laterally sealed by two annular seals, each extending between the cylindrical inner surface of said roller and the outer surface of said shaft; preferably, each annular seal is arranged between a section of the cylindrical inner surface of said roller and a section of the outer surface of said shaft, which sections are, where appropriate, outside with respect to said bearings; preferably still, the annular seals are chosen from metallic seals, comprising, for example, two sealing rings, a first sealing ring of which is rotationally locked with the cylindrical inner surface of said roller and a second sealing ring is rotationally locked with the outer surface of said shaft, or lip seals, comprising, for example, a lip seal rotationally locked with the cylindrical inner surface of said roller and a sealing ring rotationally locked with the outer surface of said shaft;
said shaft comprises two terminal sections cooperating with a complementary through-hole of said links, which means of rotation locking comprise an assembly between a non-circular lateral portion of said terminal section, for example a portion comprising a flat, and a link comprising a complementary through-hole;
the roller and/or its associated shaft include means of translational locking, adapted to maintain said shaft in its through-hole, for example stops carried by the ends of said shaft;
the shafts each have at least one conduit for filling the sealed chamber with said lubricating fluid, which conduit has two orifices, namely an external orifice, advantageously opening at one end of said shaft, and an internal orifice, opening into the sealed chamber.

The present invention also relates to a bearing module, intended for an offshore application, comprising:
a roller chain according to the invention,
a guide body receiving said roller chain,

which roller chain forms a recirculating roller chain comprising:
an active strand designed to cooperate with a complementary rolling path, and
a return strand.

The present invention also relates to offshore equipment, comprising at least one bearing module according to the invention, adapted to installations such as a foundation pile for an offshore crane mast or an active wave compensation system.

Of course, the different features, variants and embodiments of the invention can be combined with each other in various ways as long as they are not incompatible or mutually exclusive.

### DETAILED DESCRIPTION OF THE INVENTION

Furthermore, various other features of the invention become apparent from the attached description made with reference to the drawings which illustrate non-limiting embodiments of the invention and where:

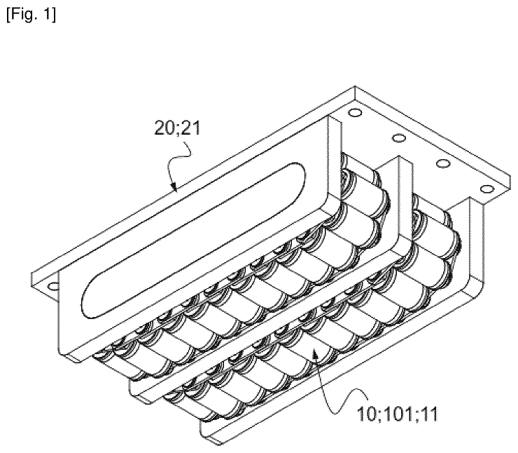

FIG. 1 is a general and perspective view of a bearing module equipped with a roller chain according to the invention;

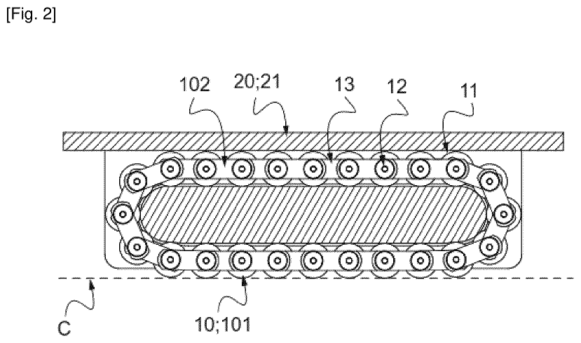

FIG. 2 is a cross-sectional and schematic view of the bearing module according to FIG. 1;

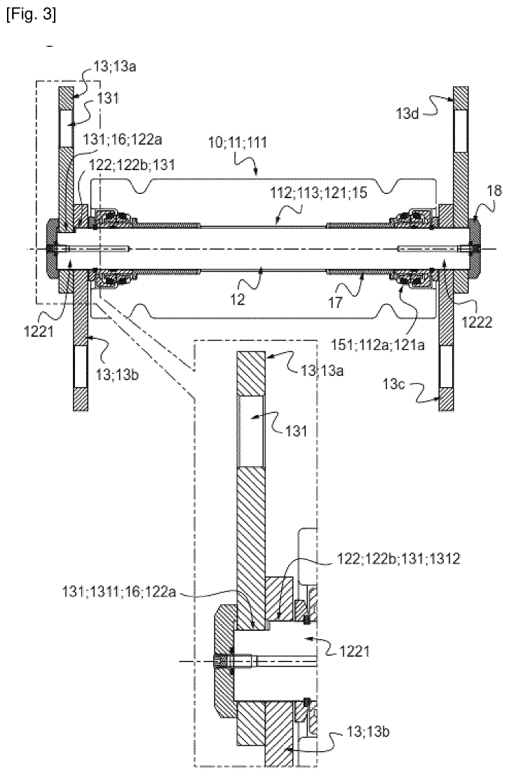

FIG. 3 is a partial and schematic view of the roller chain according to the invention, showing a roller which is fitted onto a shaft connected to links, with a partial and enlarged view of a terminal section which cooperates with two links;

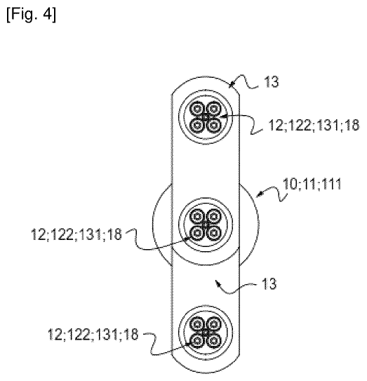

FIG. 4 is a side view of the assembly illustrated in FIG. 3;

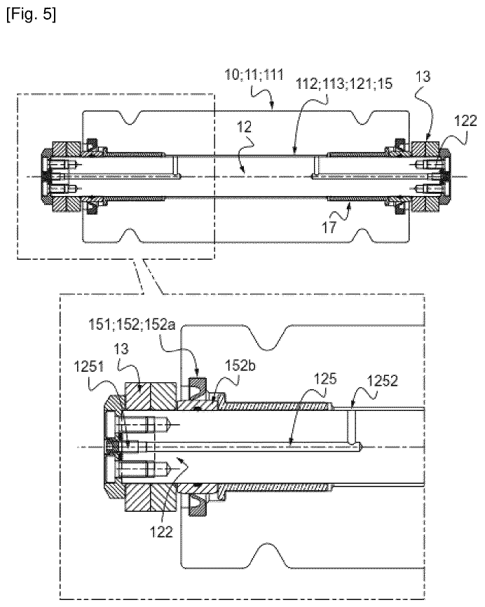

FIG. 5 is a general and partial cross-sectional view of a roller which is fitted onto a shaft, in said view, the annular joints being a first embodiment;

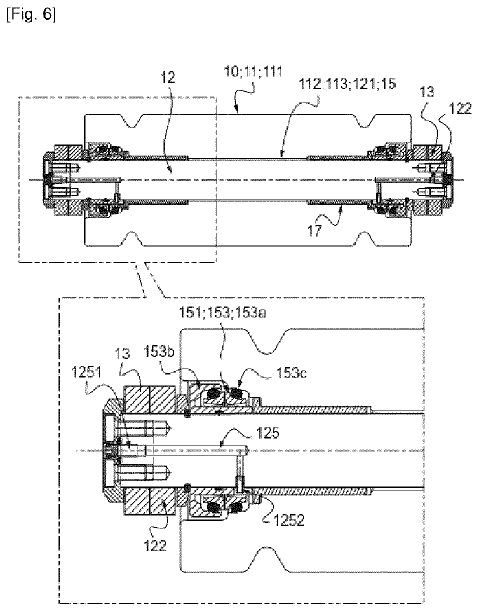

FIG. 6 is a general and partial cross-sectional view of a roller which is fitted onto a shaft, in said view, the annular joints being a second embodiment;

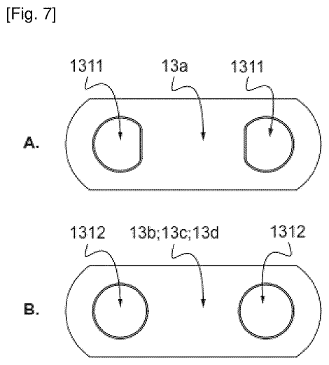

FIG. 7 is a side view of two links constituting the roller chain according to the invention.

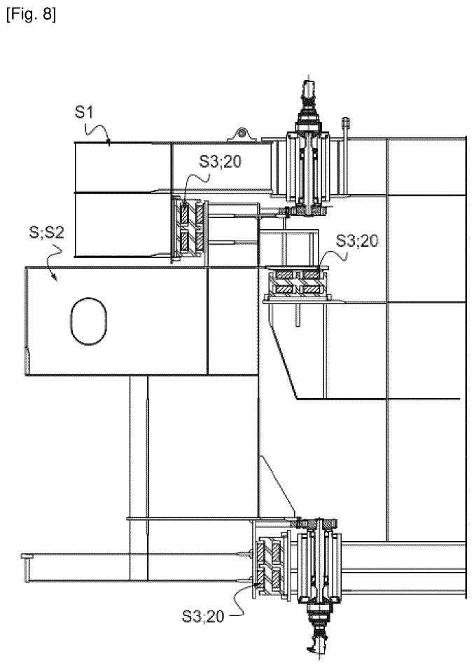

FIG. 8 is a schematic view of a first example of offshore equipment comprising bearing modules cooperating with a rotating ring for the support of a wind turbine foundation pile;

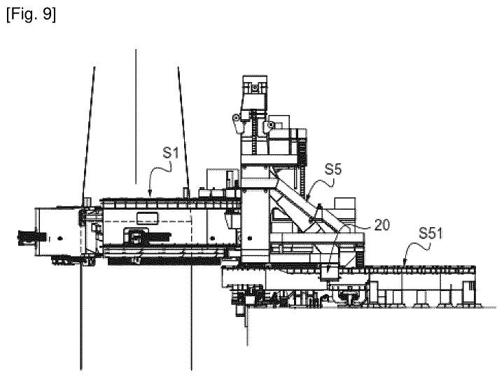

FIG. 9 is a schematic view of a second example of offshore equipment comprising bearing modules according to the invention, namely an active wave compensation system for the installation of offshore wind turbines.

It should be noted that, in these figures, the structural and/or functional elements common to the different variants may have the same references.

As shown in the figures, the present invention relates to a roller chain 10 for a recirculating bearing module 20, intended for an offshore application.

By “offshore application” we advantageously mean any use in environments located off the coast, generally in a maritime environment.

These applications are characterized by their exposure to specific environmental conditions such as:
marine constraints: exposure to salt water, humidity, corrosion and temperature variations;
dynamic conditions: presence of waves and swell in particular;
heavy loads: high mechanical stresses due to heavy equipment, such as offshore wind turbines or marine cranes.

These applications include, but are not limited to:
the installation and maintenance of offshore wind turbines;
active wave compensation systems for maritime operations;
transport and handling equipment for parcels at sea.

### BEARING MODULE

The present invention also relates to the recirculating bearing module 20, intended for an offshore application.

That recirculating bearing module 20 advantageously includes:
a roller chain 10 according to the invention,
a guide body 21 receiving this roller chain 10.

As is shown in FIG. 2, the roller chain 10 is a recirculating roller chain 10 which comprises:
an active strand 101, intended to cooperate with a complementary roller track C, and
a return strand 102.

The term “guide body” advantageously refers to a manufactured part designed to ensure the precise and stable guidance of the roller chain in a recirculating bearing module.

The guide body plays a role in delimiting and separating the two strands constituting the chain, namely the active strand and the return strand, while ensuring their proper functioning.

It geometrically defines the positions of the active strand and the return strand, thus contributing to the stability and efficiency of the bearing modules.

The guide body divides the roller chain into two segments:
the active strand, which cooperates directly with the complementary rolling path to transmit forces or support loads;
the return strand, which returns to the initial position without interacting with the rolling path.

The guide body 21 is advantageously made of wear-resistant materials suitable for the offshore environment, such as metal alloys, reinforced composites or technical polymers.

### Roller Chain

In general and as illustrated in general in FIGS. 2 and 3, the roller chain 10 comprises several rollers 11 which are each fitted onto a shaft 12.

And, each shaft 12 is connected to an adjacent shaft 12 by two (lateral) links 13.

In other words, each shaft 12 is connected to:
an adjacent first shaft 12 by a first pair of links 13, and
an adjacent second shaft 12 by a second pair of links 13.

Thus, each link 13 provides the connection between two adjacent shafts 12, allowing a continuous mechanical connection to be created along the roller chain.

Advantageously, each link 13 consists of a metal plate having two (through) holes 131, each one being intended to cooperate with a shaft 12.

More specifically, the 11 tubular rollers each comprise:
a cylindrical outer surface 111, intended to cooperate with the roller track C and
an internal cylindrical surface 112, defining a through-hole 113 into which a shaft 12 is fitted.

And each shaft 12 has an outer surface 121 opposite the cylindrical inner surface 112 of the corresponding roller 11.

According to the invention, the rollers 11 are free to rotate relative to their associated shafts 12.

This feature allows for independent rotational movement between each roller and its corresponding shaft. This configuration contributes to reducing friction at the shaft/link assembly and improving the mechanical performance of the roller chain.

According to a preferred embodiment, the roller 11 and its associated shaft 12 cooperate by means of rotary assembly means 17.

These rotary assembly means 17 are advantageously chosen from among:
plain bearings, or
rolling bearings.

The term “plain bearings” advantageously refers to mechanical elements that guide and support the rotational movement of the roller 11 relative to its associated shaft 12, without using rolling components. These plain bearings generally consist of a contact surface that allows sliding between the parts, while reducing friction.

By “roller bearings” we advantageously mean mechanical devices which allow the support and guidance of a rotational movement of the roller 11 relative to its associated shaft 12, minimizing friction through the use of rolling components such as balls, rollers or needles.

The rotary assembly means 17 are advantageously fixed between the cylindrical inner surface 112 of the roller 11 and the outer surface 121 of said shaft 12.

Preferably, the rotary assembly means 17 comprise two bearings 17, for example:
two plain flanged bearings (FIG. 3 in particular), advantageously made of bronze, which are here secured to the cylindrical inner surface 112, or
two rolling contact bearings (not shown), for example ball bearings, roller bearings or needle bearings.

Furthermore, each shaft 12 has two terminal sections 122 which cooperate with a through-hole 131 complementary to the links 13.

The terminal sections 122 extend in projection from the associated roller 11, on either side of this associated roller 11.

More specifically, each terminal section 122 is capable of being inserted through a through-hole 131 in two juxtaposed links 13, such that:
a first link 13 is intended to cooperate with, on one side, said shaft 12 and, on the other side, a first adjacent shaft 12 and
a second link 13 is intended to cooperate with, on one side, said shaft 12 and, on the other side, a second adjacent shaft 12.

Still according to the invention, the cylindrical inner surface 112 of the roller 11 and the outer surface 121 of said shaft 12 define a sealed chamber 15 which is filled with a lubricating fluid.

This fluid fills the sealed chamber 15, created between the cylindrical inner surface of the roller and the outer surface of the shaft. In particular, this lubricating fluid reduces friction between the roller and the shaft, thus promoting smooth movement and reducing mechanical wear.

For example, and in a classic way, the lubricating fluid is chosen from among the lubricating fluids suitable for offshore applications, for example greases or oils.

Preferably, the sealed chamber 15 is laterally sealed by two annular seals 151 which each extend between the cylindrical inner surface 112 of the roller 11 and the outer surface 121 of the shaft 12.

Each annular joint 151 is preferably arranged between a section 112a of the cylindrical inner surface 112 of the roller 11 and a section 121a of the outer surface 121 of the shaft 12.

The two sections 112a, 121a, opposite each other, are, where appropriate, preferably outside in relation to the assembly means 17.

In other words, the assembly means 17 are advantageously positioned between the annular seals 151, within the sealed chamber 15.

In still other words, the terminal sections 122 extend from the annular joints 151.

According to an embodiment illustrated in FIG. 5, the annular seals 151 consist of lip seals 152 which include, for example:
a lip seal 152a locked against rotation (and in a watertight manner) with the cylindrical inner surface 112 of the roller 11 and
a sealing ring 152b locked against rotation (and in a sealed manner) with the outer surface 121 of said shaft 12.

According to an embodiment illustrated in FIG. 6, the annular seals 151 consist of metal seals 153 (also called “mechanical face seal”), comprising, for example, two sealing rings of which:
a first sealing ring 153a is rotationally locked with the cylindrical inner surface of the roller 11 and
a second sealing ring 153b is rotationally locked with the outer surface 121 of said shaft 12.

Preferably, these sealing rings 153a, 153b consist of identical metallic friction rings mounted against each other and centered in their location by two elastomer elements 153c exerting a uniform axial pressure.

These sealing rings 153a, 153b are in rotation relative to each other, following the relative rotational movement between the roller 11 and its shaft 12.

The seal between these sealing rings 153a, 153b is ensured by friction between the two elements in contact.

Preferably and generally, each shaft 12 has at least one conduit 125 for filling the sealed chamber 15 with the lubricating fluid.

As illustrated in FIG. 5, this conduit 125 has two orifices:
an external opening 1251, advantageously opening at one end of the shaft 12 and intended to be sealed (for example, at least with a plug), and
an internal opening 1252, opening into the sealed chamber 15.

For example, the 125 duct has an L-shape, with:
a first section extending coaxially to shaft 12, and
a second section extending perpendicularly to the axis of this shaft 12.

Still according to the invention, each shaft 12 is locked in rotation with at least one of the associated links 13 by means of rotational locking means 16.

Preferably, one link 13 is locked against rotation with two adjacent shafts 12. And the other links 13 are free to rotate with respect to the two adjacent shafts 12.

Preferably, the shafts move linearly along both strands (active and return) without rotating around their axis. This movement is made possible by mechanically locking the shafts with certain links, preventing their rotation. Furthermore, the rollers, mounted on the shafts, pivot freely around them. This configuration ensures that the rollers, and not the shafts, provide the rotation necessary for the system to function.

Friction is thus concentrated at the interfaces between the rollers and the shafts, where it is reduced thanks to the presence of the lubricating fluid in the sealed chamber.

By avoiding the rotation of the shafts, friction between the shafts and the links is minimized, which limits heating and mechanical wear of the components.

To this end, advantageously, the rotational locking means 16 comprise an assembly between:
a non-circular lateral portion 122a of a first terminal segment 1221 (on the left in the partial view of FIG. 3), for example a cylindrical portion with a flat section, and
a first link 13a having a complementary, non-circular through-hole 1311 (FIG. 7A.).

Advantageously, the first terminal section 1221 also includes a circular lateral portion 122b (on the right in the partial view of FIG. 3) adapted to cooperate with a complementary circular through-hole 1312 in a second link 13b (FIG. 7B). This assembly allows rotation between the shaft 12 and this second link 13b.

Preferably, the second terminal section 1222 has a circular lateral portion suitable for cooperating with the complementary circular through-holes 1312 of a third link 13c and a fourth link 13d (FIG. 7B.).

This assembly allows rotation between the second terminal section 1222 of the shaft 12 and the two associated links 13c, 13d.

According to a preferred embodiment, the first link 13a is rotationally locked with two adjacent shafts 12. And the other links 13.

In this case, the first link 13a advantageously has two non-circular through-holes 1311 (FIG. 7A). And the other links 13b, 13c and 13d advantageously have two circular through-holes 1312 (FIG. 7B).

In general terms, the roller 11 and/or its associated shaft 12 include translational locking means 18, adapted to maintain this shaft 12 in its through-hole 113.

These translational locking means 18 consist for example of stops which are carried by the ends of the shaft 12.

These stops 18 consist for example of added discs, the diameter of which is greater than the diameter of the terminal sections 122 of the shaft 12.

Preferably, the links 13 are then advantageously held laterally on a terminal section 122 by:
a stop 18 on the outside, and
a 151 seal on the inside.

### Offshore Equipment

The bearing module 20 according to the invention is suitable for equipping offshore equipment as shown in FIGS. 8 and 9.

According to a first embodiment illustrated in FIG. 8 and as described in document FR3135098A1, the bearing module according to the invention can equip a temporary support system, for the temporary support, during pile-driving operations, of a foundation pile intended to receive the mast of an offshore wind turbine.

The temporary support system S includes a sleeve S1 intended to encircle a section of a foundation pile and a supporting frame S2 including an interface module S3.

The interface module S3 and the sleeve S1 are assembled by means of bearing means comprising bearing modules according to the invention, intended to give a degree of freedom in rotation to said sleeve S1 relative to said carrier chassis S2.

According to a second embodiment illustrated in FIG. 9 and as described in document FR3135098A1, a carrier frame S5 may include sliding means S51 and operating means (not shown, intended to generate displacements of the sleeve S1 according to translational degrees of freedom.

The S51 slide means comprise at least one rolling element advantageously consisting of recirculating rolling modules 20 according to the invention.

### Implementation of the Roller Chain

According to the invention, certain links 13 are specifically locked against rotation on the adjacent shafts 12 to which they are connected, using dedicated locking means 16.

This locking is achieved, for example, by means of a non-circular portion 122a of the terminal sections 1221 of the shafts 12, such as a flat, which fits into a through-hole 1311 complementary to the concerned links 13. This configuration prevents any relative rotation between the shafts and these associated links.

This structural arrangement has the advantage of defining a preferred rotation ratio between the rollers and their shafts. In other words, the chain movement is concentrated at the interfaces between the rollers and the shafts, while the shafts remain fixed in rotation relative to the locked links 13a. This feature minimizes the mechanical stresses exerted on the links 13.

The chain's movements within its guide body primarily generate relative rotation between the rollers and the shafts. Consequently, the rotation of the links relative to the shafts is limited to the movements strictly necessary for the chain's operation within the recirculating bearing module.

This configuration also helps preserve the links by reducing wear resulting from repeated movements. By limiting localized mechanical stresses on critical connection points, particularly in dynamic and demanding environments such as offshore applications, the device ensures greater component longevity.

1. Roller chain (10) for a recirculating bearing module (20), intended for offshore application,
which roller chain (10) comprises several rollers (11) which are each fitted onto a shaft (12),
each shaft (12) having an outer surface (121) and being connected to an adjacent shaft (12) by two links (13),
characterized in that said rollers (11), of tubular shape, each comprise:
a cylindrical outer surface (111), and
a cylindrical inner surface (112), defining a through-hole (113) into which said shaft (12) is fitted,
which rollers (11) are free to rotate relative to their associated shafts (12),
which cylindrical inner surface (112) of said roller (11) and which outer surface (121) of said shaft (12) define a sealed chamber (15) which is filled with a lubricating fluid,
and in that each shaft (12) is rotationally locked with at least one of said associated links (13) by means of rotational locking means (16).

2. Roller chain (10) according to claim 1, characterized in that the roller (11) and its associated shaft (12) cooperate by means of rotational assembly means (17), advantageously chosen from plain bearings or rolling bearings, advantageously fixed between said cylindrical inner surface (112) of said roller (11) and said outer surface (121) of said shaft (12).

3. Roller chain (10) according to claim 2, characterized in that the rotational assembly means (17) comprise two bearings, for example:
two plain flanged bearings, advantageously made of bronze, which are secured to said cylindrical inner surface (112), or
two rolling bearings, for example ball bearings, roller bearings or needle bearings.

4. Roller chain (10) according to claim 1, characterized in that said sealed chamber (15) is laterally sealed by two annular seals (151) which each extend between the cylindrical inner surface (112) of said roller (11) and the outer surface (121) of said shaft (12).

5. Roller chain (10) according to claim 4, characterized in that each annular joint (151) is arranged between a section (112a) of the cylindrical inner surface (112) of said roller (11) and a section (121a) of the outer surface (121) of said shaft (12),
which sections (11a; 121a) are where appropriate outside in relation to said bearings (17).

6. Roller chain (10) according to claim 4, characterized in that the annular joints (151) are selected from:
the metal seals (153), comprising for example two sealing rings, of which a first sealing ring (153a) is rotationally locked with the cylindrical inner surface (112) of said roller (11) and a second sealing ring (153b) is rotationally locked with the outer surface (121) of said shaft (12), or
lip seals (152), comprising for example a lip seal (152a) rotationally locked with the cylindrical inner surface (112) of said roller (11) and a sealing ring (152b) rotationally locked with the outer surface (121) of said shaft (12).

7. Roller chain (10) according to claim 1, characterized in that said shaft (12) comprises two terminal sections (122) cooperating with a through-hole (131; 1311; 1312) complementary to said links (13),
which rotational locking means (16) comprise an assembly between:
a non-circular lateral portion (122a) of said terminal section (122), for example a portion comprising a flat section, and
a link (13) having a complementary through-hole (1311).

8. Roller chain (10) according to claim 1, characterized in that the roller (11) and/or its associated shaft (12) have translational locking means (18), adapted to hold said shaft (12) in its through-hole (113), for example stops carried by the ends of said shaft (12).

9. Roller chain (10) according to claim 1, characterized in that the shafts (12) each comprise at least one conduit (125) for filling the sealed chamber (15) with said lubricating fluid,
which conduit (125) has two openings:
an external opening (1251), advantageously opening at one end of said shaft (12), and
an internal opening (1252), opening into the sealed chamber (15).

10. Bearing module, intended for offshore application, comprising:
a roller chain (10) according to claim 1,
a guide body (21) receiving said roller chain (11),
which roller chain (10) forms a recirculating roller chain (10) comprising:
an active strand (101) intended to cooperate with a rolling path (C), complementary, and
a return strand (102).

11. Offshore equipment, comprising at least one bearing module according to claim 10, adapted to installations such as a foundation pile or an active wave compensation system.

12. Roller chain (10) according to claim 2, wherein the roller (11) and its associated shaft (12) cooperate by means of rotational assembly means (17) chosen from plain bearings or rolling bearings.

13. Roller chain (10) according to claim 12, wherein the roller (11) and its associated shaft (12) cooperate by means of rotational assembly means (17) chosen from plain bearings or rolling bearings, fixed between said cylindrical inner surface (112) of said roller (11) and said outer surface (121) of said shaft (12).
